(19) United States
(12) Patent Application Publication
(10) Pub. No.: US 2011/0242393 A1
(43) Pub. Date: Oct. 6, 2011

(54) IMAGING DEVICE AND METHOD FOR CAPTURING IMAGES WITH PERSONAL INFORMATION

(75) Inventor: CHI-SHENG GE, Tu-Cheng (TW)

(73) Assignee: HON HAI PRECISION INDUSTRY CO., LTD., Tu-Cheng (TW)

(21) Appl. No.: 12/843,065

(22) Filed: Jul. 26, 2010

(30) Foreign Application Priority Data
Mar. 30, 2010 (TW) 99109713

(51) Int. Cl. H04N 5/222

(52) U.S. Cl. 348/333.02; 348/E05.022

(57) ABSTRACT

A method for capturing images applied in an imaging device is provided. The imaging device includes an image capturing unit having a field of view. The imaging device is capable of sensing first position information and determining which orientation the image capturing unit faces, and further communicates with portable communication devices some of which are in field of view and receiving a second position information and personal information. The method includes the establishment of a coordinate system and converting the first position information and the second position information to the set of coordinates. The method includes: first determining whether one of the portable communication devices is in the field of view. Then, determining which person of the captured image corresponds to one of the portable communication devices, and associating the personal information with the determined person of the captured image. Next, generating a composite image.

### BACKGROUND

1. Technical Field

The present disclosure relates to image devices and methods for capturing images.

2. Description of Related Art

In order to make each person recognizable in an image by people who do not know him/her or who have forgotten his/her name, the conventional way is to manually add personal information, for example names, to images, which is time consuming and inconvenient.

### BRIEF DESCRIPTION OF THE DRAWINGS

The components of the drawings are not necessarily drawn to scale, the emphasis instead being placed upon clearly illustrating the principles of an imaging device and of a method for capturing images. Moreover, in the drawings, like reference numerals designate corresponding parts throughout several views.

FIG. 1 is a schematic view of an imaging device in accordance with an exemplary embodiment.

FIG. 2 is a block diagram of the imaging device of FIG. 1.

FIG. 3 is a schematic view showing an image with personal information.

FIG. 4 is a schematic view employed to illustrate how to determine whether one portable communication device is within the field of view of the imaging device of FIG. 1. Field of view hereinafter refers to the imaging field the imaging device is capable of capturing images.

FIG. 5 is a flowchart of a method for capturing an image in accordance with an exemplary embodiment.

### DETAILED DESCRIPTION

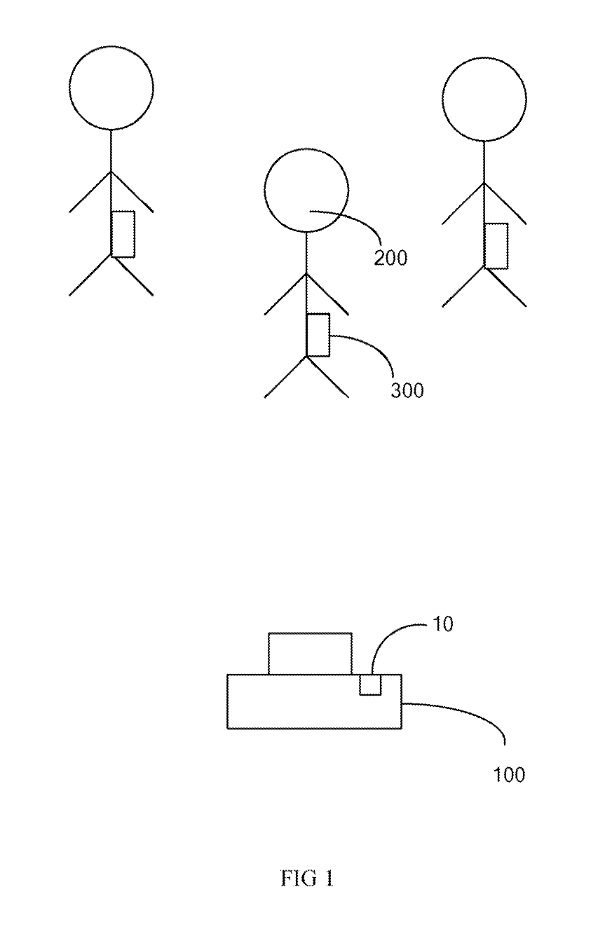

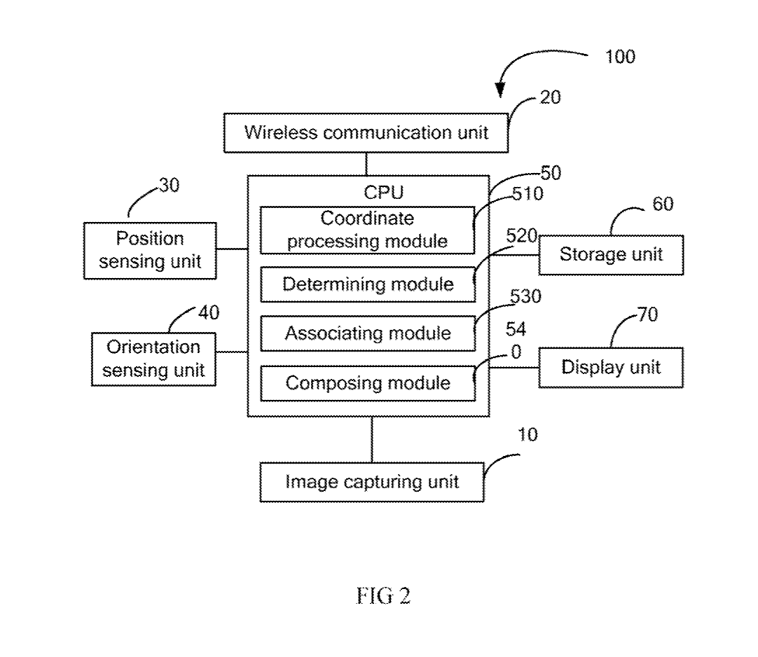

Referring to FIGS. 1-2, an imaging device 100 in accordance with an exemplary embodiment is shown. The imaging device 100 includes an image capturing unit 10 used to capture images. In the embodiment, the imaging device 100 captures an image of each of the persons 200 who wears a portable communication device 300 communicating with the imaging device 100. The imaging device 100 can sense first position information of the imaging device 100 and determine which orientation the image capturing unit 10 should face. Each portable communication device 300 can sense second position information of the portable communication device 300 and transmit the second position information and personal information edited according to a request from the device 100 from the device 300. The imaging device 100 can determine whether one portable communication device 300 is in field of view of the image capturing unit 10 according to the first position information, the determined orientation, and the second position information of each portable communication device 300. If a particular portable communication device 300 is in field of view, the imaging device 100 further determines which person 200 of the captured image corresponds to the portable communication device 300, according to the second position information. When the imaging device 100 determines which person 200 corresponds to the portable communication device 300, the imaging device 100 associates the personal information from the portable communication device 300 with the determined person 200. The imaging device 100 then generates a composite image according to the relationship between each determined person 200 and the associated personal information.

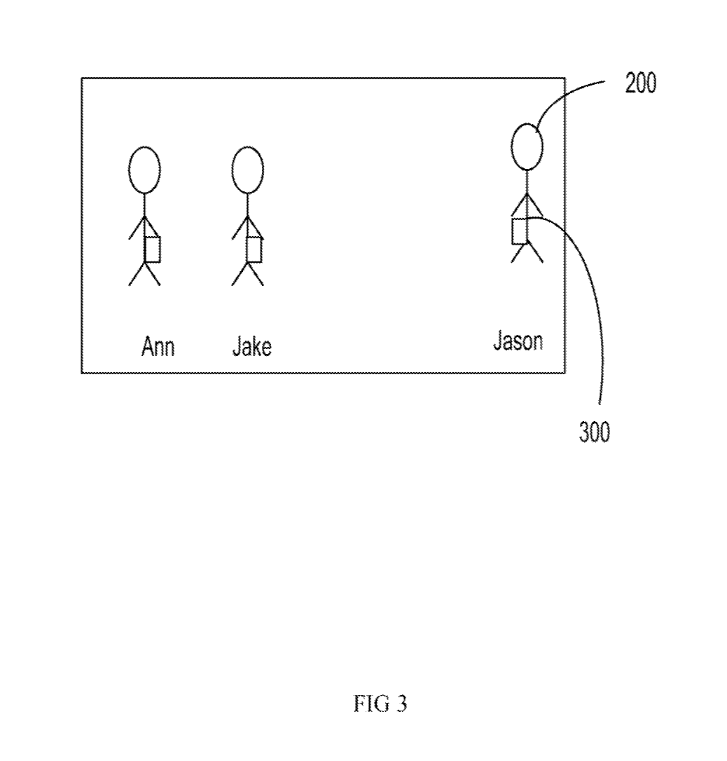

In the embodiment, the composite image includes the personal information within the field of view. Therefore, each person in the composite image can be recognized according to their personal information. As shown in FIG. 3, in the embodiment, the personal information from each portable communication device 300 within field of view is a name, for example, Ann, Jake, or Jason, of the person 200 wearing the portable communication device 300.

The imaging device 100 further includes a wireless communication unit 20, a position sensing unit 30, an orientation sensing unit 40, a central processing unit (CPU) 50, a storage unit 60, and a display unit 70.

The imaging device 100 communicates with the devices 300 through the wireless communication unit 20.

The position sensing unit 30 is configured to sense the first position information of the imaging device 100. In the embodiment, the position sensing unit 30 is a Global Position System (GPS). The first position information is the longitude and latitude of the imaging device 100. The orientation sensing unit 40 is configured to sense which orientation the image capturing unit 10 faces. In the embodiment, the orientation sensing unit 40 includes and uses a compass.

The CPU 50 includes a coordinate processing module 510, a determining module 520, an associating module 530, and a composing module 540.

The coordinate processing module 510 is configured to form a coordinate system according to the first position information and the orientation; and convert the first position information and the second position information of each portable communication device 300 into set of coordinates according to the coordinate system. In the embodiment, the coordinate system is the Descartes coordinate system. The coordinate origin is the intersection of the position sensing unit 30 and the orientation, that is, the first position information is converted to the coordinate (X=0, Y=0).

The determining module 520 is configured to determine whether a particular portable communication device 300 is in the field of view of the imaging device 100 according to the Descartes coordinate system and the coordinates of the portable communication device 300.

If a portable communication device 300 is in the field of view of the imaging device 100, the associating module 530 determines which person of the captured image corresponds to the portable communication device 300 according to its second position information, and associates the personal information from the portable communication device 300 with the determined person 200.

The composing module 540 is configured to generate a composite image according to the relationship between each determined person 200 and the personal information associated with the determined person 200. The composite image is then stored in the storage unit 60.

The display unit 70, for example, is configured to display information of the composite image.

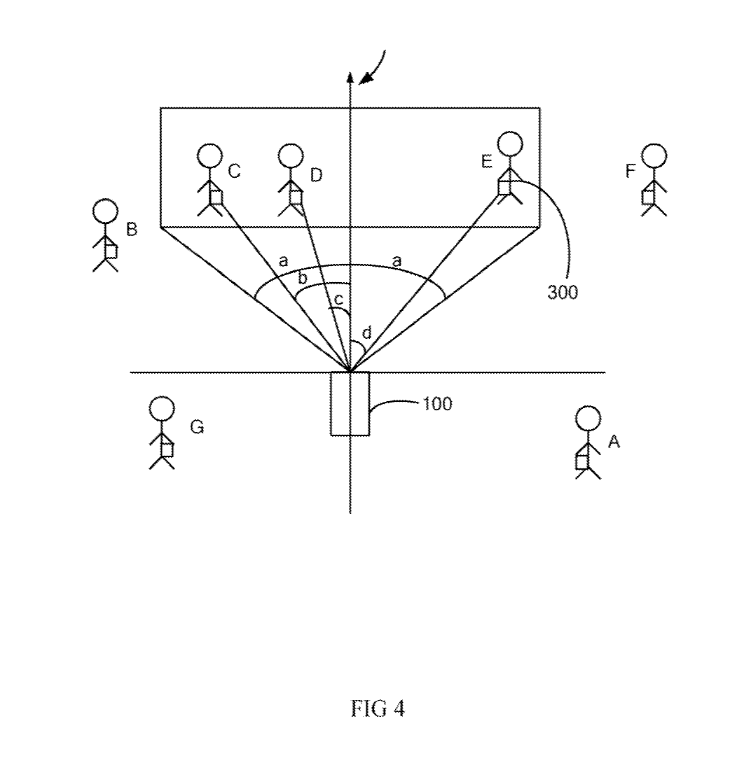

FIG. 4 is a schematic view employed to illustrate how to determine whether a portable communication device 300 is in the field of view of the imaging device 100. In FIG. 4, there are people illustrated by A, B, C, D, E, F, and G. After capturing an image of the field of view area “2a”, the imaging device 100 sends a request to the portable communication devices 300 worn by the people A, B, C, D, E, F, and G. Each portable communication device 300 then transmits the second position information and edits personal information corresponding to the request to the imaging device 100. The imaging device 100 determines the Descartes coordinate system and converts the first position information and the second position information of each portable communication device 300 into set of coordinates. The imaging device 100 then determines the angle between each portable communication device 300 and the image capturing unit 10 according to the Descartes coordinate system and then converts a set of coordinates. If the angle of a particular portable communication device 300 and position sensing unit 30 is less than “a”, the imaging device 100 determines the portable communication device 300 namely the person wearing the portable communication device 300 is in the field of view. In the embodiment, the angle “b”, “c” and “d” are less than “a”, that is, the people C, D, and E are within the field of view.

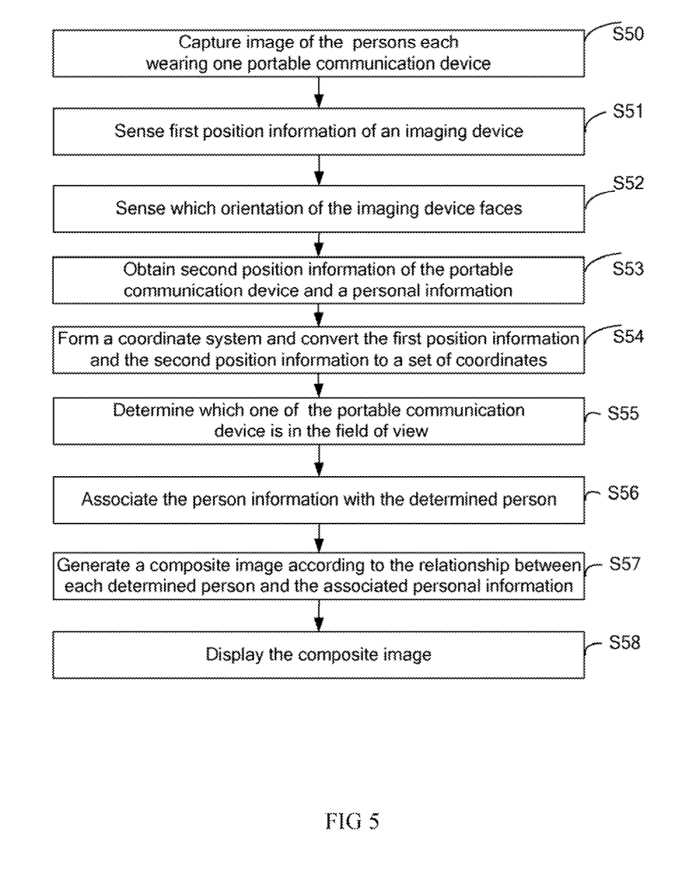

FIG. 5 is a flowchart of a method for capturing an image in accordance with an exemplary embodiment.

In step S50, the image capturing unit 10 captures an image of the people 200 each wearing a portable communication device 300.

In step S51, the position sensing unit 30 senses the first position information of the imaging device 100.

In step S52, the orientation sensing unit 40 senses which orientation the image capturing unit 10 faces.

In step S53, the wireless communication unit 20 obtains the second information of each portable communication device 300 and the personal information edited corresponding to the request from the imaging device 100 from each portable communication device 300.

In step S54, the coordinate processing module 510 forms a coordinate system according to the first position information and the orientation, and converts the first position information and the second position information of each portable communication device 300 to the set of coordinates according to the coordinate system.

In step S55, the determining module 520 determines the portable communication devices 300 which are in the field of view of the image capturing unit 10 according to the coordinate system and the set of coordinates of the portable communication device 300.

In step S56, the associating module 530 determines which person 200 of the captured image corresponds to the portable communication device 300 according to the set of coordinates of the portable communication device 300, and associates the personal information with the determined person 200.

In step S57, the composing module 540 generates a composite image according to relationship between each determined person 200 and the personal information associated with the determined person 200.

In step S58, the display unit 70 displays the composite information.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An imaging device, comprising:
an image capturing unit having a field of view, the image capturing unit being configured to capture an image;
a position sensing unit configured to sense first position information of the imaging device;
an orientation sensing unit configured to sense which orientation the image capturing unit faces;
a wireless communication unit communicating with a plurality of portable communication devices some of which are in the field of view and configured to receive second position information of each of the portable communication devices and personal information from each of the portable communication devices; and
a central processing unit (CPU) to:
form a coordinate system and convert the first position information and the second position information into set of coordinates according to the coordinate system, the origin of the coordinate system being the intersection of the determined orientation and the position sensing unit;
determine whether one of the portable communication devices is in the field of view according to the coordinate system and the set of coordinate of the one of the portable communication devices;
determine which person of the captured image corresponds to one of the portable communication devices according to the second position information of the one of the portable communication devices if the one of the portable communication devices is in the field of view, and associate the personal information from one of the portable communication devices with the determined person of the captured image; and
generate a composite image according to the relationship between each determined person of the captured image and the personal information associated with each determined person of the captured image.

2. The imaging device as described in claim 1, wherein the CPU is further to determine that one of the portable communication devices is in the field of view when the angle between the imaging device and the one of the portable communication devices is less than half of the field of view according to the coordinate system and the set of coordinates of the portable communication devices.

3. The imaging device as described in claim 1, wherein the coordinate system is a Descartes coordinate system.

4. The imaging device as described in claim 1 further comprising a storage unit configured to store images.

5. The imaging device as described in claim 1 further comprising a display unit configured to display images.

6. The imaging device as described in claim 1, wherein the orientation sensing unit comprises a compass.

7. The imaging device as described in claim 1, wherein the position sensing unit is a GPS.

8. An imaging device, comprising
an image capturing unit having a field of view to capture image;
a position sensing unit configured to sense first position information of the image capturing unit;
an orientation sensing unit configured to sense which orientation of the image capturing unit faces;
a wireless communication unit communicating with a portable communication device, and configured to obtain second position information and the personal information; and
a CPU, comprising
a coordinate processing module configured to form a coordinate system and convert the first position information and the second position information to the set of coordinates according to the coordinate system, the origin of the coordinate system being the intersection of the determined orientation and the position sensing unit;
a determining module configured to determine whether one portable communication device is in the field of view according to the coordinate system and the set of coordinate of the one of the portable communication devices;
an associating module configured to determine which person of the captured image corresponds to the portable communication devices, and then associating the personal information from the one of the portable communication device with the determined person of the captured image; and
a composing module configured to generate a composite image according to the relationship between each determined person of the captured image and the personal information associated with each determined person of the captured image.

9. The imaging device as described in claim 8 further comprising a storage unit configured to store images.

10. The imaging device as described in claim 8 further comprising a display unit configured to display images.

11. The imaging device as described in claim 8, wherein the determining module is configured to determine one of the portable communication devices is in the field of view when the angle between the imaging device and the one of the portable communication devices is less than half of the field of view according to the coordinate system and the set of coordinate of the one of the portable communication devices.

12. A method for capturing images applied in an imaging device, the imaging device comprising an image capturing unit having a field of view, the imaging device comprising a position sensing unit capable of sensing first position information and determining which orientation the image capturing unit faces, the imaging device communicating with a plurality of portable communication devices some of which are in the field of view and receiving second position information and personal information of each of the portable communication devices, the method comprising:
forming a coordinate system and converting the first position information and the second position information to the set of coordinates according to the coordinate, the origin of the coordinate system being the intersection of the determined orientation and the position sensing unit;
determining whether one of the portable communication devices is in the field of view according to the coordinate system and the set of coordinates of the one of the portable communication devices;
determining which person of the captured image corresponds to one of the portable communication devices, and associating the personal information from the one of the portable communication devices with the determined person of the captured image; and
generating a composed image according to the relationship between each determined person of the captured image and the personal information associated with each determined person of the captured image.

13. The method of capturing image as described in claim 12, wherein the step of determining whether one of the portable communication devices is in the field of view according to the coordinate system and the set of coordinates of the one of the portable communication devices comprises:
determining that one portable communication device is in the field of view when the angle between the imaging device and the one of the portable communication devices is less than half of the field of view according to the coordinate system and the set of coordinate of the one of the portable communication devices.

14. The method of capturing image as described in claim 12 further comprising displaying the composed image.
